(19) United States
(12) Patent Application Publication
(10) Pub. No.: US 2026/0070259 A1
(43) Pub. Date: Mar. 12, 2026

(54) RELEASE FILM AND METHOD FOR MANUFACTURING MULTILAYER ELECTRONIC COMPONENT USING THE SAME

(71) Applicant: SAMSUNG ELECTRO-MECHANICS CO., LTD., Suwon-si (KR)

(72) Inventors: Jae Won KIM, Suwon-si (KR); Jung Jin PARK, Suwon-si (KR); Ho Jun LEE, Suwon-si (KR); Dae Jin SHIM, Suwon-si (KR); Jong Ho LEE, Suwon-si (KR)

(73) Assignee: SAMSUNG ELECTRO-MECHANICS CO., LTD., Suwon-si (KR)

(21) Appl. No.: 19/252,542

(22) Filed: Jun. 27, 2025

(30) Foreign Application Priority Data
Sep. 10, 2024 (KR) 10-2024-0123296

(51) Int. Cl. B28B 7/36; H01G 4/33

(52) U.S. Cl. CPC B28B 7/36; H01G 4/33

(57) ABSTRACT

A release film includes a substrate layer, and a release layer disposed on one surface of the substrate layer, and including a cured product of a release composition, wherein, when a surface of the release layer is analyzed using X-ray photoelectron spectroscopy (XPS), a ratio (Si/C) of an amount (at %) of silicon to an amount (at %) of carbon is 0.15 to 0.20, and a surface hardness measured by a nanoindentation method is 200 MPa to 300 MPa, and the other surface of the substrate layer facing the one surface has a center line average roughness Ra of 15 nm or less.

### CROSS-REFERENCE TO RELATED APPLICATION(S)

This application claims benefit of priority to Korean Patent Application No. 10-2024-0123296 filed on Sep. 10, 2024 in the Korean Intellectual Property Office, the disclosure of which is incorporated herein by reference in its entirety.

### TECHNICAL FIELD

The present disclosure relates to a release film, and a method for manufacturing a multilayer electronic component using the same.

Generally, a release film using a polyester film as a substrate and forming a release layer thereon may be used to form a ceramic green sheet used in manufacturing a multilayer electronic component, for example, a multilayer ceramic capacitor (hereinafter, referred to as ‘MLCC’).

Recently, as a thickness of the ceramic green sheet decreases in order to miniaturize the MLCC, a problem has arisen in which wrinkles or breakage defects occur in the ceramic green sheet, when separating the ceramic green sheet from the release film.

In addition, the release film may be generally produced in a roll-to-roll manner, and in this case, the ceramic green sheet and a surface of the release film, opposite thereto, (a surface opposite to a surface on which the release layer is disposed) are in strong contact, which may cause a problem in which the ceramic green sheet is damaged.

When a MLCC is manufactured with a damaged ceramic green sheet, since there may be a concern that short-circuiting defects of the MLCC or the like may occur, research on a release film capable of forming a ceramic green sheet with fewer defects is required.

### SUMMARY

An aspect of the present disclosure is to provide a release film capable of forming a ceramic green sheet with fewer defects.

The purpose of the present disclosure is not limited to the contents, and will be more easily understood in the process of explaining specific embodiments of the present disclosure.

According to an aspect of the present disclosure, a release film includes a substrate layer, and a release layer disposed on a first surface of the substrate layer, and including a cured product of a release composition, wherein, when a surface of the release layer is analyzed using X-ray photoelectron spectroscopy (XPS), a ratio (Si/C) of an amount (at %) of silicon to an amount (at %) of carbon is 0.15 to 0.20, and a surface hardness measured by a nanoindentation method is 200 MPa to 300 MPa, while a second surface of the substrate layer facing the first surface has a center line average roughness Ra of 15 nm or less.

### BRIEF DESCRIPTION OF DRAWINGS

The and other aspects, features, and advantages of the present disclosure will be more clearly understood from the following detailed description, taken in conjunction with the accompanying drawings, in which:

FIG. 1 is a cross-sectional view schematically illustrating a release film according to an embodiment of the present disclosure.

FIG. 2 is a cross-sectional view schematically illustrating a state in which a ceramic green sheet is formed on the release film of FIG. 1.

FIG. 3 is a cross-sectional view schematically illustrating a multilayer electronic component manufactured using a release film according to an embodiment of the present disclosure.

### DETAILED DESCRIPTION

Hereinafter, embodiments of the present disclosure will be described with reference to specific embodiments and the attached drawings. However, embodiments of the present disclosure may be modified in various other forms, and the scope of the present disclosure is not limited to embodiments described below. In addition, embodiments of the present disclosure may be provided to more completely explain the present disclosure to those skilled in the art. Therefore, shapes and sizes of elements in the drawings may be exaggerated for clarity, and elements indicated by the same symbols in the drawings may be the same elements.

In addition, in order to clearly explain the present disclosure in the drawings, since portions not related to the explanation may be omitted, and a size and a thickness of each component illustrated in the drawings may be arbitrarily indicated for the convenience of explanation, the present disclosure is not necessarily limited to what is illustrated. In addition, components with the same functions within the scope of the same idea may be described using the same reference symbols. Furthermore, throughout the specification, when a portion is said to “include” a certain component, this does not mean that other components are excluded, but rather that other components are included, unless otherwise specifically stated.

Throughout the specification, “-based compound,” “-based resin,” “-based polymer,” and/or “-based copolymer” may be broad concepts including “˜ compound,” “˜ resin,” “˜ polymer,” “˜ copolymer,” or/and derivatives thereof. In addition, in the present specification, “compound” may be a broad concept including “monatomic molecule,” “oligomer,” and “polymer compound including homopolymer and copolymer.” In addition, unless specifically defined otherwise in the present specification, a unit of “parts by weight” means a weight ratio between components, and a unit of “parts by mass” means a weight ratio between components converted into a solid state.

### Release Film

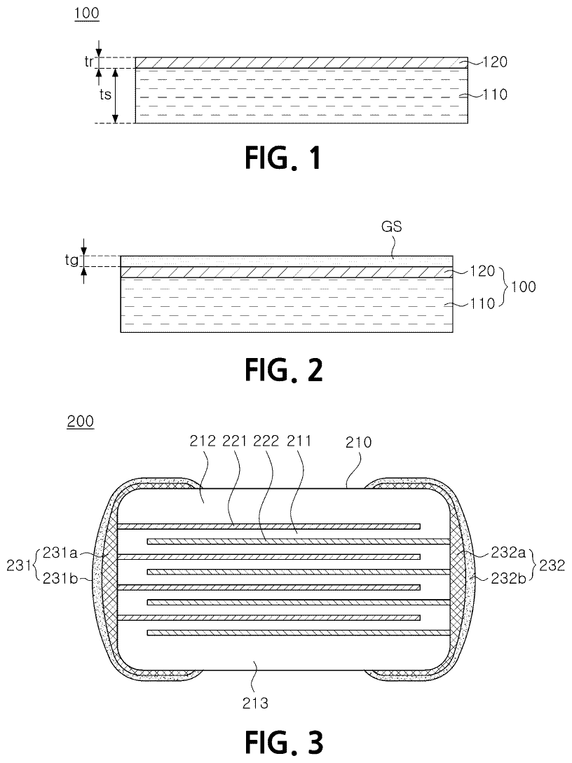

FIG. 1 is a cross-sectional view schematically illustrating a release film according to an embodiment of the present disclosure. FIG. 2 is a cross-sectional view schematically illustrating a state in which a ceramic green sheet is formed on the release film of FIG. 1. A release film 100 according to an embodiment of the present disclosure may include a substrate layer 110 and a release layer 120 disposed on one surface of the substrate layer 110.

### (Substrate Layer)

A substrate layer 110 may be a substrate film or a substrate sheet. The substrate layer 110 may be, for example, a polyester-based substrate film. The polyester-based substrate film may include, for example, one or more of polyethylene terephthalate, polybutylene terephthalate, and polyethylene naphthalate. The polyester-based substrate film may be obtained, for example, by polycondensing an aromatic dicarboxylic acid and an aliphatic glycol. Examples of the aromatic dicarboxylic acid may include isophthalic acid, phthalic acid, terephthalic acid, 2,6-naphthalenedicarboxylic acid, adipic acid, sebacic acid, or oxycarboxylic acid. Examples of the aliphatic glycol may include ethylene glycol, diethylene glycol, propylene glycol, butanediol, 1,4-cyclohexanedimethanol, or neopentyl glycol. The polyester-based substrate film may use two or three or more of the dicarboxylic acid components and glycol components in combination. In addition, the polyester-based substrate film may be a uniaxially or biaxially stretched oriented film.

Considering heat resistance, chemical resistance, strength, economy, or the like, the substrate layer 110 may be a polyethylene terephthalate (PET) film. The PET film may be formed, for example, by polycondensing terephthalic acid and ethylene glycol, and may be formed, for example, by using a direct method using terephthalic acid, but the present disclosure is not limited thereto.

The other surface of the substrate layer 110 facing one surface of the substrate layer 110 on which the release layer 120 is disposed may have a center line average roughness Ra (hereinafter, referred to as Ra₁) of 15 nm or less. When the center line average roughness Ra₁ of the other surface of the substrate layer 110 is within the range defined above, the other surface of the substrate layer 110 may be significantly planarized.

When the release film 100 is produced in a roll-to-roll manner, a surface of the substrate layer 110, opposite to a surface on which the release layer 120 is disposed (hereinafter, referred to as the other surface of the substrate layer) may come into strong contact. In this case, when the center line average roughness Ra₁ of the other surface of the substrate layer 110 is excessively high, a ceramic green sheet GS may be damaged, and quality of a multilayer electronic component may deteriorate due to the damaged ceramic green sheet GS. According to an embodiment of the present disclosure, the center line average roughness Raj of the other surface of the substrate layer 110 may satisfy 15 nm or less, thereby preventing damage to the ceramic green sheet GS and improving quality of the multilayer electronic component. A lower limit of the center line average roughness Ra₁ of the other surface of the substrate layer 110 is not particularly limited, but may be, for example, more than 0 nm. Alternatively, to improve windability of the release film 100, the center line average roughness Raj of the other surface of the substrate layer 110 may be 5 nm or more.

A maximum height roughness Rmax (hereinafter, referred to as Rmax₁) of the other surface of the substrate layer 110 may be, for example, 300 nm or less. When the maximum height roughness Rmax₁ of the other surface of the substrate layer 110 may be within the range defined above, the other surface of the substrate layer 110 may be remarkably planarized. The maximum height roughness Rmax₁ of the other surface of the substrate layer 110 may satisfy 300 nm or less, thereby preventing damage to the ceramic green sheet GS and improving quality of the multilayer electronic component. A lower limit of the maximum height roughness Rmax₁ of the other surface of the substrate layer 110 is not particularly limited, but may be, for example, more than 0 nm. Alternatively, to improve windability of the release film 100, the maximum height roughness Rmax₁ of the other surface of the substrate layer 110 may be 50 nm or more.

When the center line average roughness Ra₁ of the other surface of the substrate layer 110 is 15 nm or less and the maximum height roughness Rmax₁ of the other surface of the substrate layer 110 is 300 nm or less, a damage prevention effect of the ceramic green sheet GS of the present disclosure may be more remarkable.

In an embodiment, a center line average roughness Ra (hereinafter, referred to as Ra₂) of a surface of the substrate layer 110 on which the release layer 120 is disposed may be greater than 0 nm and less than or equal to 15 nm. When the center line average roughness Raz of the surface of the substrate layer 110 on which the release layer 120 is disposed may be greater than 15 nm, the release layer 120 may be damaged due to protrusions of the substrate layer 110 during a winding process, and may cause stamped damage to the ceramic green sheet GS after a molding process is completed.

In an embodiment, if the center line average roughness Ra of the surface of the release layer contacting the ceramic green sheet GS during the molding process is Ra₃, a ratio (Ra₃/Ra₁) of the center line average roughness Ra₃ of the surface of the release layer to the center line average roughness Ra₁ of the other surface of the substrate layer 110 may be 0.05 to 0.95. When Ra₃/Ra₁ satisfies the range defined above, it is possible to suppress defects such as stamping of the ceramic green sheet GS, or the like.

In the present specification, the center line average roughness Ra and the maximum height roughness Rmax may be measured according to the ISO 25178 (Geometric Product Specifications (GPS)—Surface texture: areal) standard. The center line average roughness Ra and the maximum height roughness Rmax may be measured using, for example, a three-dimensional contact-type surface roughness measuring device. Other methods and/or tools appreciated by one of ordinary skill in the art, even if not described in the present disclosure, may also be used.

To control slipperiness and surface roughness of the release film 100, the substrate layer 110 may include, for example, one or more particles of silica, silicon oxide, calcium carbonate, calcium sulfate, calcium phosphate, magnesium carbonate, magnesium phosphate, barium carbonate, kaolin, aluminum oxide, and titanium oxide. Shapes of the particles may be, for example, any of a spherical shape, a blocky shape, a rod shape, or a plate shape, but there may be no limitation on the shapes of the particles used.

As necessary, two or more types of the particles may be used in parallel, and an average particle diameter of the particles used may be about 30 nm to 1 μm. When the average particle diameter of the particles is less than 30 nm, poor dispersion may occur, and when the average particle diameter of the particles exceeds 1 μm, the surface roughness of the substrate layer 110 may increase, which may cause damage to the ceramic green sheet GS.

A thickness ts of the substrate layer 110 does not need to be particularly limited, but may be, for example, 10 μm or more and 200 μm or less. Since the thickness ts of the substrate layer 110 may be 10 μm or more, deformation of the substrate layer 110 due to heat may be suppressed. In addition, since the thickness ts of the substrate layer 110 may be 200 μm or less, an amount of the substrate layer 110 discarded after use may be suppressed, thereby reducing environmental burden.

### (Release Layer)

A release layer 120 may include a cured product of a release composition. The release composition may include, for example, polydimethylsiloxane and a cyclic compound.

### 1. Polydimethylsiloxane

Polydimethylsiloxane may be an additive for imparting release properties to a release layer 120. The polydimethylsiloxane may be combined with a cyclic compound to improve durability of the release layer 120. The polydimethylsiloxane included in a release composition may have a polar functional group.

The polar functional group may be introduced at one end or both ends of the polydimethylsiloxane, and a position at which the polar functional group is introduced may be one or more. The polydimethylsiloxane may have one or more of a hydroxyl group, a carboxyl group, an amino group, an amine group, a carbonyl group, an acrylic group, an acryloyl group, a nitrile group, a vinyl group, a halogen group, a urethane group, and an ester group as the polar functional group. The polydimethylsiloxane included in the release composition may have a hydroxyl group for bonding with the cyclic compound, for example.

An amount of the polydimethylsiloxane included in the release composition may be, for example, 1 part by weight or more and 15 parts by weight or less, based on 100 parts by weight of a sum of the polydimethylsiloxane and the cyclic compound. A weight average molecular weight of the polydimethylsiloxane included in the release composition need not be particularly limited, but may be 1,000 or more and 500,000 or less.

### 2. Cyclic Compound

A cyclic compound may be a main component of a release layer 120. The cyclic compound included in the release composition may include one or more of an aromatic compound and a heteroaromatic compound. The cyclic compound may contribute to the release layer 120 having a high elastic modulus and may prevent a ceramic green sheet GS having a folding defect (so-called wrinkle defect), when peeling the ceramic green sheet GS formed on the release layer 120.

The cyclic compound may include, for example, one or more of a melamine-based compound, a pyridine-based compound, a naphthalene-based compound, and a benzene-based compound. More preferably, the cyclic compound may include one or more of a melamine-based compound, a pyridine-based compound, and a naphthalene-based compound. The melamine-based compound may include a compound represented by the following chemical formula 1, a polymer thereof, a copolymer thereof, and/or a derivative thereof.

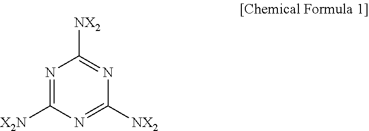

(Where, X represents a hydrogen atom, or —CH₂—O—R¹, each X being the same or different. R¹ represents a hydrogen atom, or an alkyl group having 1 to 8 carbon atoms, each R¹ being the same or different.)

The pyridine-based compound may include a compound represented by the following chemical formula 2, a polymer thereof, a copolymer thereof, and/or a derivative thereof.

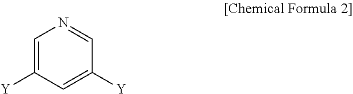

(Where, Y represents —NH₂, —OH, —COOH, —CH₂—O—R², —CONR³₂, or a phenyl group substituted with a carboxyl group, each Y being the same or different. Each of R² and R³ represents a hydrogen atom, or an alkyl group having 1 to 8 carbon atoms, each R² and R³ being the same or different.)

The naphthalene-based compound may include a compound represented by the following chemical formula 3, a polymer thereof, a copolymer thereof, and/or a derivative thereof.

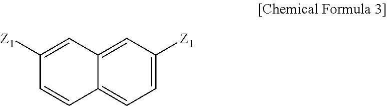

(Where, Z₁ represents —NH₂, —OH, —COOH, —CH₂—O—R⁴, —CONR⁵₂, or a phenyl group substituted with a carboxyl group, each Z being the same or different. Each of R⁴ and R⁵ represents a hydrogen atom, or an alkyl group having 1 to 8 carbon atoms, each R⁴ and R⁵ being the same or different.)

The benzene-based compound may include a compound represented by the following chemical formula 4, a polymer thereof, a copolymer thereof, and/or a derivative thereof.

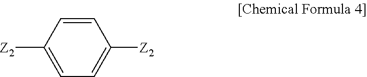

(Where, Z₂ represents —NH₂, —OH, —COOH, —CH₂—O—R⁶, —CONR⁷₂, or a phenyl group substituted with a carboxyl group, each Z₂ being the same or different. Each of R⁶ and R⁷ represents a hydrogen atom, or an alkyl group having 1 to 8 carbon atoms, each R⁶ and R⁷ being the same or different.)

### 3. Acid Catalyst and Solvent

In addition to the components mentioned above, a release composition may further include an acid catalyst and a solvent. The acid catalyst may play a role in promoting a crosslinking reaction with a cyclic compound included in the release composition.

The acid catalyst may include, for example, one or more of methanesulfonic acid, trifluoromethanesulfonic acid, isoprenesulfonic acid, camphorsulfonic acid, hexanesulfonic acid, octanesulfonic acid, nonanesulfonic acid, decanesulfonic acid, hexadecanesulfonic acid, dinonylnaphthalenesulfonic acid, dinonylnaphthalenedisulfonic acid, benzenesulfonic acid, alkylbenzenesulfonic acid, paratoluenesulfonic acid, melamine trisulfonic acid, cumenesulfonic acid, dodecylbenzenesulfonic acid, naphthalenesulfonic acid, and nonylnaphthalenesulfonic acid, but the present disclosure is not limited thereto.

An amount of the acid catalyst to be added may be, for example, 0.1 to 10 parts by weight relative to 100 parts by weight of the cyclic compound. When an amount of the acid catalyst is less than 0.1 parts by weight, a curing reaction may be delayed, and when an amount of the acid catalyst exceeds 10 parts by weight, storage stability of the release composition may be reduced.

The solvent may be any solvent compatible with the cyclic compound. The solvent may include, for example, one or more of acetone, methyl ethyl ketone, methyl isobutyl ketone, cyclohexanone, toluene, xylene, methanol, ethanol, butanol, isopropyl alcohol, isobutyl alcohol, ethyl acetate, butyl acetate, propyl acetate, isopropyl acetate, hexane, heptane, octane, and isooctane.

In addition, the release composition may further include a binder, a conductivity improver, a pH regulator, and/or a surfactant, etc., within a range in which characteristics of the release layer is not changed.

### 4. Characteristics of Release Layer

When a surface of a release layer 120 is analyzed using X-ray photoelectron spectroscopy (XPS), a ratio (Si/C) of an amount (at %) of silicon to an amount (at %) of carbon may be 0.15 or more and 0.20 or less. Other methods and/or tools appreciated by one of ordinary skill in the art, even if not described in the present disclosure, may also be used. In XPS analysis of the surface of the release layer 120, the amount of silicon (Si) may be mostly derived from polydimethylsiloxane.

In this case, when the ratio of the amount of silicon to the amount of carbon is less than 0.15, a release property may be insufficient, resulting in a problem of high peeling force, and a defect in which a ceramic green sheet GS is not peeled off from the release film 100 (so-called non-peeling defect) may occur. When the ratio of the amount of silicon to the amount of carbon exceeds 0.20, a wrinkle defect in which the ceramic green sheet GS folds may occur when peeling the ceramic green sheet GS from the release film.

The release layer 120 may include silicon (Si), carbon (C), nitrogen (N), and oxygen (O). In an embodiment, the release layer 120 may substantially not include fluorine (F). Therefore, a release film 100, which is environmentally friendly halogen-free, may be provided. In the present specification, “substantially not include fluorine” or “be substantially free of” may mean that a fluorine (F) component is not intentionally added to the release composition for forming the release layer. For example, in a manufacturing process of the release layer 120 or the like, there is a possibility that a very small amount of a fluorine component or the like, which may unexpectedly exist, may be included. Considering this, when the surface is analyzed using XPS, the release layer 120 may have a ratio (F/Si) of an amount (at %) of fluorine (F) to an amount (at %) of silicon (Si) of 0.01 or less.

The release layer 120 may have a surface hardness of 200 MPa or more and 300 MPa or less as measured by a nanoindentation method. When the surface hardness of the release layer 120 as measured by the nanoindentation method is less than 200 MPa, a problem in which a degree of hardening of the surface of the release layer 120 is low may occur, and when the ceramic green sheet GS is peeled from the release film 100, a wrinkle defect in which the ceramic green sheet GS is folded may occur. When the surface hardness of the release layer 120 as measured by the nanoindentation method exceeds 300 MPa, a degree of hardening of the surface of the release layer 120 may increase, or a fracture defect of the ceramic green sheet GS may occur. Other methods and/or tools appreciated by one of ordinary skill in the art, even if not described in the present disclosure, may also be used.

In an embodiment, a surface energy of the release layer 120 may be 28 mN/m or more and 30 mN/m or less. The surface energy of the release layer 120 may be related to an application property and peeling force of the release layer 120. Specifically, as the surface energy of the release layer 120 increases, an application property of a ceramic slurry applied on the release layer 120 may increase, and as the surface energy of the release layer 120 decreases, peeling force of the release film 100 may increase.

When the surface energy of the release layer 120 is less than 28 mN/m, wettability and smoothness may deteriorate in applying the ceramic slurry on the release layer 120. In addition, when the surface energy of the release layer 120 exceeds 30 mN/m, there may be a concern that peeling force of the release film 100 may increase excessively, resulting in a defect in non-peeling. The surface energy of the release layer 120 may be obtained by a wetting tension method. Other methods and/or tools appreciated by one of ordinary skill in the art, even if not described in the present disclosure, may also be used.

A thickness tr of the release layer 120 does not need to be particularly limited. The thickness tr of the release layer 120 may be 75 nm or more and 250 nm or less, taking into consideration release performance, smoothness of a surface of the release layer, or the like. In this case, the thickness tr of the release layer 120 may mean an average thickness of the release layer 120. For example, the average thickness of the release layer 120 may be obtained by measuring a thickness of the release layer 120 five times while moving an observation position using a scanning electron microscope (SEM) or a transmission electron microscope (TEM), and then calculating an average value therefrom. Other methods and/or tools appreciated by one of ordinary skill in the art, even if not described in the present disclosure, may also be used.

### Method for Manufacturing Multilayer Electronic Component

FIG. 3 is a cross-sectional view schematically illustrating a multilayer electronic component 200 manufactured using a release film according to an embodiment of the present disclosure.

A multilayer electronic component 200 may include a body 210 including a dielectric layer 211 and internal electrodes 221 and 222, and external electrodes 231 and 232 disposed outside the body 210 and connected to the internal electrodes 221 and 222. More specifically, the multilayer electronic component 200 may include a first external electrode 231 connected to a first internal electrode 221, and a second external electrode 232 connected to a second internal electrode 222.

In addition, the body 210 may include a capacitance forming portion in which capacitance is formed, including the first and second internal electrodes 221 and 222 alternately disposed with the dielectric layer 211 therebetween, and the cover portions 212 and 213 disposed on both surfaces facing the capacitance forming portion in a first direction.

Hereinafter, an example of a method for manufacturing a multilayer electronic component 200 using a release film 100 according to an embodiment of the present disclosure will be described. The release film 100 according to an embodiment of the present disclosure, described above, may be used as a carrier film for forming a ceramic green sheet GS.

### (Dielectric Layer)

First, ceramic powder particles for forming a dielectric layer 211 may be prepared. The ceramic powder particles are not particularly limited as long as sufficient electrostatic capacity is obtained. For example, a barium titanate-based material, a lead composite perovskite-based material, a strontium titanate-based material, or the like may be used. Examples of the ceramic powder particles may include BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, (Ca₁₋ₓSrₓ)(Zr_{1-y}Ti_{y})O₃ (0≤x<0.5, 0≤y≤0.5), or the like. Among the ceramic powder particles, BaTiO₃ may be synthesized, for example, by reacting a titanium raw material such as titanium dioxide or the like with a barium raw material such as barium carbonate or the like. A synthesis method of the ceramic powder particles may include, for example, a solid-phase method, a sol-gel method, a hydrothermal synthesis method, or the like, but the present disclosure is not limited thereto.

Next, a ceramic slurry may be prepared by mixing the ceramic powder particles, an organic solvent such as ethanol or the like, and a binder such as polyvinyl butyral or the like. Thereafter, the ceramic slurry may be applied and dried on a release film 100 according to an embodiment of the present disclosure, to form a ceramic green sheet GS. An average thickness tg of the ceramic green sheet GS does not need to be particularly limited, but may be, for example, 0.5 μm to 5.0 μm.

### (Internal Electrode)

Next, an internal electrode pattern may be formed on the ceramic green sheet GS. The internal electrode pattern may be sintered to form the internal electrodes 221 and 222. The internal electrode pattern may be formed by printing a conductive paste for internal electrode containing metal powder particles, a binder, or the like on the ceramic green sheet GS at a predetermined thickness using a screen printing method, a gravure printing method, or the like. The metal powder particles may include, for example, one or more of Ni, Cu, Pd, Ag, Au, Pt, Sn, W, Ti, and alloys thereof, but the present disclosure is not limited thereto.

### (Stacking and Cutting)

Next, after the ceramic green sheet GS on which the internal electrode pattern is formed may be peeled off from the release film 100, a plurality of ceramic green sheets GS may be stacked and pressed to form a ceramic stack. In addition, to form the cover portions 212 and 213, a predetermined number of ceramic green sheets GS on which the internal electrode pattern is not printed may be stacked on upper and lower portions of the ceramic stack.

The ceramic stack may be cut into a predetermined chip size as needed. In addition, the binder or the like included in the ceramic stack or the cut chip may be preferably removed through a debinding process. Conditions of the debinding process may be changed, depending on a type of binder used, and are not particularly limited.

Thereafter, the ceramic stack or the cut chip may be sintered. A sintering temperature is not particularly limited, but may be, for example, 1000° C. or higher and 1300° C. or lower. The ceramic stack or the cut chip may be formed into a body 210 including the dielectric layer 211 and the internal electrodes 221 and 222 by sintering.

### (External Electrode)

Finally, the external electrodes 231 and 232 may be formed. First, electrode layers 231a and 232a may be formed by dipping the body 210 into a conductive paste including metal powder particles and glass, and then sintering the same. In this case, a sintering temperature may be, for example, 700° C. to 900° C. The electrode layers 231a and 232a may be formed of only the sintered electrode layer including metal and glass, but the present disclosure is not limited thereto, and the electrode layers 231a and 232a may have a multilayer structure. For example, the electrode layers 231a and 232a may include a sintered electrode layer including metal and glass, and a resin electrode layer disposed on the sintered electrode layer and including metal particles and a resin.

Next, plating layers 231b and 232b may be formed using an electrolytic plating method and/or an electroless plating method, or the like. The plating layers 231b and 232b may be a plating layer including Ni, Sn, Pd, and/or alloys including them, and may be formed as multiple layers. For example, the plating layers 231b and 232b may be in a form in which a Ni plating layer and a Sn plating layer are sequentially formed.

The manufacturing method is illustrative, and a method of manufacturing the multilayer electronic component 200 is not limited to the manufacturing method.

Hereinafter, a configuration of the present disclosure and effects thereof will be described in more detail through Inventive Examples and Comparative Examples. However, the following Inventive Examples are intended to explain the present disclosure more specifically, and are obvious that the scope of the present disclosure is not limited to the following Experimental Examples.

### INVENTIVE EXAMPLES

### Inventive Example 1-1

Based on 100 parts by weight of a sum of polydimethylsiloxane (PDMS) and melamine, 11 parts by weight of polydimethylsiloxane, 89 parts by weight of melamine, and 0.5 parts by weight of paratoluene sulfonic acid as a catalyst were added to isopropyl alcohol as a solvent, to prepare a release composition. The release composition was applied onto a polyester base film, and a curing heat treatment was performed in a hot air dryer at 120° C. for 1 minute. As a result, a release layer having an average thickness of 250 nm, after curing, was formed, thereby preparing a release film.

### Inventive Example 1-2

A release film was prepared in the same manner as in Inventive Example 1-1, except that 3 parts by weight of polydimethylsiloxane and 97 parts by weight of melamine were used based on 100 parts by weight of a sum of polydimethylsiloxane and melamine, and that an average thickness of a release layer after curing was 130 nm.

### Inventive Example 1-3

A release film was prepared in the same manner as in Inventive Example 1-1, except that 9 parts by weight of polydimethylsiloxane and 91 parts by weight of melamine were used based on 100 parts by weight of a sum of polydimethylsiloxane and melamine, and that an average thickness of a release layer after curing was 155 nm.

### Inventive Example 1-4

A release film was prepared in the same manner as in Inventive Example 1-1, except that 1 part by weight of polydimethylsiloxane and 99 parts by weight of melamine were used based on 100 parts by weight of a sum of polydimethylsiloxane and melamine, and that an average thickness of a release layer after curing was 170 nm.

### Inventive Example 2-1

Ammeline was used instead of melamine as a cyclic compound. A release film was prepared in the same manner as in Inventive Example 1-1, except that 15 parts by weight of polydimethylsiloxane and 85 parts by weight of ammeline were used based on 100 parts by weight of a sum of polydimethylsiloxane and ammeline, and that an average thickness of a release layer after curing was 150 nm.

### Inventive Example 2-2

A release film was prepared in the same manner as in Inventive Example 2-1, except that 5 parts by weight of polydimethylsiloxane and 95 parts by weight of ammeline were used based on 100 parts by weight of a sum of polydimethylsiloxane and ammeline, and that an average thickness of a release layer after curing was 90 nm.

### Inventive Example 3-1

Naphthalenediamine (naphthalene-2,7-diamine) was used instead of melamine as a cyclic compound. A release film was prepared in the same manner as in Inventive Example 1-1, except that 2 parts by weight of polydimethylsiloxane and 98 parts by weight of naphthalenediamine were used based on 100 parts by weight of a sum of polydimethylsiloxane and naphthalenediamine, and that an average thickness of a release layer after curing was 75 nm.

### Inventive Example 3-2

A release film was prepared in the same manner as in Inventive Example 3-1, except that 14 parts by weight of polydimethylsiloxane and 86 parts by weight of naphthalenediamine were used based on 100 parts by weight of a sum of polydimethylsiloxane and naphthalenediamine, and that an average thickness of a release layer after curing was 130 nm.

### Inventive Example 4-1

Dicarboxyphenylpyridine (3,5-di(3-carboxyphenyl)pyridine) was used instead of melamine as a cyclic compound. A release film was prepared in the same manner as in Inventive Example 1-1, except that 1.5 parts by weight of polydimethylsiloxane and 98.5 parts by weight of dicarboxyphenylpyridine were used based on 100 parts by weight of a sum of polydimethylsiloxane and dicarboxyphenylpyridine, and that an average thickness of a release layer after curing was 120 nm.

### Inventive Example 4-2

A release film was prepared in the same manner as in Inventive Example 4-1, except that 13 parts by weight of polydimethylsiloxane and 87 parts by weight of dicarboxyphenylpyridine were used based on 100 parts by weight of a sum of polydimethylsiloxane and dicarboxyphenylpyridine, and that an average thickness of a release layer after curing was 230 nm.

Compositions, amounts, and average thicknesses of the release layers of Inventive Examples 1-1 to 4-2 were summarized in Table 1 below.

TABLE 1

| | | | | Average |
|---|---|---|---|---|
| | | Weight Ratio (%) | | Thickness |
| Inventive | Cyclic | Cyclic | | of Release |
| Examples | Compound | Compound | PDMS | Layer (nm) |
| 1-1 | Melamine | 89.0% | 11.0% | 250 |
| 1-2 | | 97.0% | 3.0% | 130 |
| 1-3 | | 91.0% | 9.0% | 155 |
| 1-4 | | 99.0% | 1.0% | 170 |
| 2-1 | Ammeline | 85.0% | 15.0% | 150 |
| 2-2 | | 95.0% | 5.0% | 90 |
| 3-1 | Naphthalenediamine | 98.0% | 2.0% | 75 |
| 3-2 | | 86.0% | 14.0% | 130 |
| 4-1 | Dicarboxyphenylpyridine | 98.5% | 1.5% | 120 |
| 4-2 | | 87.0% | 13.0% | 230 |

### Comparative Example 1-1

A release film was prepared in the same manner as in Inventive Example 1-1, except that 17 parts by weight of polydimethylsiloxane and 83 parts by weight of melamine were used based on 100 parts by weight of a sum of polydimethylsiloxane and melamine, and that an average thickness of a release layer after curing was 100 nm.

### Comparative Example 1-2

A release film was prepared in the same manner as in Comparative Example 1-1, except that only 100 parts by weight of melamine was used without using polydimethylsiloxane.

### Comparative Example 1-3

A release film was prepared in the same manner as in Comparative Example 1-1, except that 1.5 parts by weight of polydimethylsiloxane, 98.5 parts by weight of melamine, and 1 part by weight of paratoluene sulfonic acid as a catalyst were used based on 100 parts by weight of a sum of polydimethylsiloxane and melamine, and that a curing heat treatment for a release composition was performed in a hot air dryer at 120° C. for 2 minutes.

### Comparative Example 1-4

A release film was prepared in the same manner as in Comparative Example 1-1, except that 7 parts by weight of polydimethylsiloxane and 93 parts by weight of melamine were used based on 100 parts by weight of a sum of polydimethylsiloxane and melamine, and that an average thickness of a release layer after curing was 140 nm.

### Comparative Example 2-1

Ammeline was used instead of melamine as a cyclic compound. A release film was prepared in the same manner as in Inventive Example 1-1, except that 21 parts by weight of polydimethylsiloxane and 79 parts by weight of ammeline were used based on 100 parts by weight of a sum of polydimethylsiloxane and ammeline, and that an average thickness of a release layer after curing was 130 nm.

### Comparative Example 2-2

A release film was prepared in the same manner as in Comparative Example 2-1, except that 0.5 parts by weight of polydimethylsiloxane and 99.5 parts by weight of ammeline were used based on 100 parts by weight of a sum of polydimethylsiloxane and ammeline, and that an average thickness of a release layer after curing was 375 nm.

### Comparative Example 2-3

A release film was prepared in the same manner as in Comparative Example 2-1, except that 3 parts by weight of polydimethylsiloxane, 97 parts by weight of ammeline, and 1 part by weight of paratoluene sulfonic acid as a catalyst were used based on 100 parts by weight of a sum of polydimethylsiloxane and ammeline, that a curing heat treatment for a release composition was performed in a hot air dryer at 120° C. for 2 minutes, and that an average thickness of a release layer after curing was 180 nm.

### Comparative Example 3-1

Naphthalenediamine was used instead of melamine as a cyclic compound. A release film was prepared in the same manner as in Inventive Example 1-1, except that 16 parts by weight of polydimethylsiloxane and 84 parts by weight of naphthalenediamine were used based on 100 parts by weight of a sum of polydimethylsiloxane and naphthalenediamine, and that an average thickness of a release layer after curing was 380 nm.

### Comparative Example 3-2

A release film was prepared in the same manner as in Comparative Example 3-1, except that only 100 parts by weight of naphthalenediamine was used without using polydimethylsiloxane, and that an average thickness of a release layer after curing was 200 nm.

### Comparative Example 3-3

A release film was prepared in the same manner as in Comparative Example 3-1, except that 18 parts by weight of polydimethylsiloxane and 82 parts by weight of naphthalenediamine were used based on 100 parts by weight of a sum of polydimethylsiloxane and naphthalenediamine, and that an average thickness of a release layer after curing was 240 nm.

### Comparative Example 4-1

Dicarboxyphenylpyridine was used instead of melamine as a cyclic compound. A release film was prepared in the same manner as in Inventive Example 1-1, except that 50 parts by weight of polydimethylsiloxane and 50 parts by weight of dicarboxyphenylpyridine were used based on 100 parts by weight of a sum of polydimethylsiloxane and dicarboxyphenylpyridine, and that an average thickness of a release layer after curing was 150 nm.

### Comparative Example 4-2

A release film was prepared in the same manner as in Comparative Example 4-1, except that 5 parts by weight of polydimethylsiloxane, 95 parts by weight of dicarboxyphenylpyridine, and 1 part by weight of paratoluene sulfonic acid as a catalyst were used based on 100 parts by weight of a sum of polydimethylsiloxane and dicarboxyphenylpyridine, that a curing heat treatment for a release composition was performed in a hot air dryer at 120° C. for 2 minutes, and that an average thickness of a release layer after curing was 130 nm.

### Comparative Example 4-3

A release film was prepared in the same manner as in Comparative Example 4-1, except that 9 parts by weight of polydimethylsiloxane and 91 parts by weight of dicarboxyphenylpyridine were used based on 100 parts by weight of a sum of polydimethylsiloxane and dicarboxyphenylpyridine.

### Comparative Examples 5-1 and 5-2

A release film was prepared in the same manner as in Inventive Example 1-1, except that a cyclic compound was not used, only 100 parts by weight of polydimethylsiloxane was used, and an average thickness of a release layer after curing was 50 nm.

Compositions, amounts, and average thicknesses of the release layers of Comparative Examples 1-1 to 5-2 were summarized in Table 2 below.

TABLE 2

| | | | | Average |
|---|---|---|---|---|
| | | Weight Ratio (%) | | Thickness |
| Comparative | Cyclic | Cyclic | | of Release |
| Examples | Compound | Compound | PDMS | Layer (nm) |
| 1-1 | Melamine | 83 | 17 | 100 |
| 1-2 | | 100 | 0 | 100 |
| 1-3 | | 98.5 | 1.5 | 100 |
| 1-4 | | 93 | 7 | 140 |
| 2-1 | Ammeline | 79 | 21 | 130 |
| 2-2 | | 99.5 | 0.5 | 375 |
| 2-3 | | 97 | 3 | 180 |
| 3-1 | Naphthalenediamine | 84 | 16 | 380 |
| 3-2 | | 100 | 0 | 200 |
| 3-3 | | 82 | 18 | 240 |
| 4-1 | Dicarboxyphenylpyridine | 50 | 50 | 150 |
| 4-2 | | 95 | 5 | 130 |
| 4-3 | | 91 | 9 | 150 |
| 5-1 | — | 0 | 100 | 50 |
| 5-2 | | 0 | 100 | 50 |

### Evaluation of Properties

### (XPS Analysis)

A surface of the release layer was analyzed using X-ray photoelectron spectroscopy (XPS). An apparatus used for XPS analysis was Quantera SXM of PHI, and the XPS analysis was performed in a vacuum environment. In obtained XPS spectrum, an amount (at %) of silicon acquired in a region of 95 eV to 105 eV and an amount (at %) of carbon acquired in a region of 275 eV to 295 eV were measured. Thereafter, a ratio (Si/C) of the amount of silicon to the amount of carbon was calculated.

### (Surface Hardness Measurement)

After cutting the release film to a size of 1 cm×1 cm, surface hardness was measured for the release layer using a nanoindenter analyzer (Anton Paar UNHT³) at a temperature of 25° C., a humidity of 50%, and an indentation speed of 0.1 nm/sec.

### (Surface Energy Measurement)

After dropping distilled water and methylene iodide on the surface of the release layer, a contact angle of a droplet formed on the surface of the release layer was measured using a Phoenix300Touch device. A measured contact angle value was input into Owens-Wendt model to calculate surface energy.

### (Surface Roughness Measurement)

The release film was cut to a size of 3 cm×3 cm, and then was fixed on a glass plate. Afterwards, center line average roughness Ra₁ and maximum height roughness Rmax₁ of a surface, opposite to a surface of a polyester substrate film on which the release layer was disposed were measured at a temperature of 25° C. and a humidity of 50% using a 3D microscope, Countour GTX from Bruker (measurement mode: PSI mode, measurement magnification: objective lens 20×, eyepiece lens: 2×).

### (Defect Rate Measurement of Stacking/Peeling Process)

A ceramic slurry was applied and dried on the release films to form a ceramic green sheet. Afterwards, the ceramic green sheet was peeled from the release film, and a plurality of the ceramic green sheet were stacked and sintered to produce a sample chip. The number of stacked ceramic green sheets was 300, and 10 sample chips with 300 stacked ceramic green sheets were produced for Inventive Examples and Comparative Examples, respectively.

Afterwards, a rate of defects (non-peeling defects) in which the ceramic green sheet was not peeled from the release film was measured for Inventive Examples and Comparative Examples, respectively. In addition, a cross-section of the sample chip was observed to determine whether the ceramic green sheet was peeled off from the release film, but a rate at which the ceramic green sheet was folded (wrinkle defect) and a rate at which the ceramic green sheet was broken were measured.

### (Stamping Defect Rate Measurement)

After the ceramic green sheet was produced in a roll-to-roll manner on the release films of Inventive Examples and Comparative Examples, occurrence of stamping defects in the ceramic green sheet was checked using a 3D microscope, Countour GTX, from Bruker. If even one stamping damage with a depth of 100 nm or more occurred, it was judged as defective (NG), and if no stamping damage with a depth of 100 nm or more occurred, it was judged as normal (OK).

### (Short-Circuit Rate Measurement)

MLCCs were manufactured by stacking the ceramic green sheets produced using the release films of Inventive Examples and Comparative Examples. After manufacturing a total of 100 MLCCs for Inventive Examples and Comparative Examples, respectively, capacitance of the MLCCs was measured under conditions of a frequency of 1 kHz and a voltage of 1 Vrms to check whether a short-circuit occurred.

Results of property evaluations of Inventive Examples 1-1 to 4-2 were summarized in Table 3 below.

TABLE 3

| | | | | | | Defect Rate of | | | | MLCC |
|---|---|---|---|---|---|---|---|---|---|---|
| | Release Layer | | | Substrate | | Stacking/Peeling Process | | | Sheet | Defect |
| | | Surface | Surface | Layer | | Non- | | | Defect | Short- |
| Inventive | | Hardness | Energy | Ra₁ | Rmax₁ | Peeling | Wrinkle | Fracture | Stamping | Circuit |
| Examples | Si/C | (MPa) | (dyne/cm) | (nm) | (nm) | (%) | (%) | (%) | Defect | Rate (%) |
| 1-1 | 0.190 | 230 | 28.3 | 10 | 152 | 0 | 1 | 0 | OK | 2 |
| 1-2 | 0.160 | 257 | 28.1 | 10 | 148 | 0 | 0 | 3 | OK | 0 |
| 1-3 | 0.182 | 236 | 28.6 | 11 | 168 | 0 | 0 | 1 | OK | 0 |
| 1-4 | 0.153 | 271 | 28.4 | 12 | 242 | 2 | 0 | 4 | OK | 0 |
| 2-1 | 0.199 | 211 | 29.3 | 10 | 137 | 0 | 2 | 0 | OK | 4 |
| 2-2 | 0.167 | 277 | 28.6 | 9 | 131 | 0 | 0 | 3 | OK | 0 |
| 3-1 | 0.156 | 274 | 28.4 | 12 | 212 | 0 | 1 | 3 | OK | 2 |
| 3-2 | 0.200 | 204 | 28.9 | 13 | 231 | 0 | 3 | 0 | OK | 6 |
| 4-1 | 0.154 | 284 | 28.1 | 9 | 147 | 1 | 0 | 4 | OK | 0 |
| 4-2 | 0.197 | 228 | 28.5 | 13 | 265 | 0 | 3 | 0 | OK | 6 |

Referring to Inventive Examples 1-1 to 4-2, the release layers satisfied the ratio (Si/C) of the amount of silicon to the amount of carbon of 0.15 or more and 0.20 or less when analyzing the surface using XPS, and the surface hardness measured by the nanoindentation method satisfied the ratio of 200 MPa or more and 300 MPa or less. Therefore, it can be confirmed that there are almost no peeling defects, wrinkle defects, or fracture defects.

In addition, in Inventive Examples 1-1 to 4-2, the center line average roughness Raj of the other surface of the substrate layer satisfied 15 nm or less, or the maximum height roughness Rmax₁ of the other surface of the substrate layers satisfied 300 nm or less. Therefore, it can be confirmed that no stamping defect occurs. Accordingly, it can be confirmed that when MLCCs were manufactured using the release films of Inventive Examples 1-1 to 4-2, short-circuit defects of the MLCCs almost did not occur.

Results of property evaluations of Comparative Examples 1-1 to 5-2 were summarized in Table 4 below.

TABLE 4

| | | | | | | Defect Rate of | | | | MLCC |
|---|---|---|---|---|---|---|---|---|---|---|
| | Release Layer | | | Substrate | | Stacking/Peeling Process | | | Sheet | Defect |
| | | Surface | Surface | Layer | | Non- | | | Defect | Short- |
| Comparative | | Hardness | Energy | Ra₁ | Rmax₁ | Peeling | Wrinkle | Fracture | Stamping | Circuit |
| Examples | Si/C | (MPa) | (dyne/cm) | (nm) | (nm) | (%) | (%) | (%) | Defect | Rate (%) |
| 1-1 | 0.212 | 175 | 28.1 | 9 | 142 | 0 | 25 | 0 | OK | 50 |
| 1-2 | 0.149 | 290 | 55 | 11 | 165 | 100 | 0 | 1 | OK | Non- |
| | | | | | | | | | | measurable |
| 1-3 | 0.154 | 370 | 29.4 | 12 | 182 | 0 | 0 | 29 | OK | Non- |
| | | | | | | | | | | measurable |
| 1-4 | 0.190 | 282 | 28.8 | 18 | 472 | 1 | 0 | 4 | NG | 34 |
| 2-1 | 0.227 | 189 | 29.7 | 8 | 131 | 0 | 21 | 0 | OK | 42 |
| 2-2 | 0.149 | 285 | 52 | 8 | 142 | 100 | 0 | 0 | OK | Non- |
| | | | | | | | | | | measurable |
| 2-3 | 0.162 | 331 | 27.1 | 18 | 440 | 2 | 0 | 24 | NG | Non- |
| | | | | | | | | | | measurable |
| 3-1 | 0.208 | 172 | 28.9 | 10 | 115 | 0 | 23 | 0 | OK | 46 |
| 3-2 | 0.149 | 295 | 51 | 9 | 97 | 100 | 0 | 0 | OK | Non- |
| | | | | | | | | | | measurable |
| 3-3 | 0.208 | 182 | 29.1 | 19 | 477 | 1 | 25 | 0 | NG | 85 |
| 4-1 | 0.334 | 135 | 29.1 | 7 | 82 | 0 | 31 | 0 | OK | 62 |
| 4-2 | 0.167 | 320 | 28.5 | 9 | 98 | 4 | 0 | 22 | OK | Non- |
| | | | | | | | | | | measurable |
| 4-3 | 0.184 | 256 | 28.2 | 16 | 424 | 3 | 0 | 2 | NG | 25 |
| 5-1 | 0.520 | 90 | 25.4 | 7 | 98 | 0 | 32 | 0 | OK | 64 |
| 5-2 | 0.520 | 88 | 24.7 | 20 | 512 | 0 | 28 | 0 | NG | 98 |

Referring to Comparative Examples 1-2, 2-2, and 3-2, when the ratio (Si/C) of the amount of silicon to the amount of carbon was less than 0.15 in analyzing the surface of the release layer using XPS, it can be confirmed that a release property of the release layer was insufficient, such that a non-peeling defect occurred. In addition, referring to Comparative Examples 1-1, 2-1, 3-1, 3-3, 4-1, 5-1, and 5-2, when the ratio (Si/C) of the amount of silicon to the amount of carbon exceeds 0.2 in analyzing the surface of the release layer using XPS, it can be confirmed that the surface hardness and peeling force of the release layer were reduced, resulting in wrinkle defects. When MLCC was manufactured using a ceramic green sheet with wrinkle defects, it can be confirmed that a short-circuit rate of the MLCC excessively increased.

In Comparative Examples 1-3, 2-3, and 4-2, which the surface hardness of the release layer increased by increasing a curing temperature, it can be confirmed that a fracture defect of the ceramic green sheet occurred because the surface hardness of the release layer exceeds 300 MPa. In Comparative Examples 1-2, 1-3, 2-2, 2-3, 3-2, and 4-2, the MLCC manufacturing process could not be completely performed due to occurrence of a large number of non-peeling defects or fracture defects, so the short rate could not be measured.

In addition, referring to Comparative Examples 1-4, 2-3, 3-3, 4-3, and 5-2, it can be confirmed that a stamping defect of the ceramic green sheet occurred when the center line average roughness Ra₁ of the other surface of the substrate layer exceeds 15 nm or the maximum height roughness Rmax₁ of the other surface of the substrate layer exceeds 300 nm, and when an MLCC was manufactured using a ceramic green sheet with a stamping defect, it can be confirmed that the short-circuit rate of the MLCC excessively increases.

In particular, when comparing Comparative Example 5-1 and Comparative Example 5-2, it can be confirmed that even if properties of the release layer were similar, if the center line average roughness Ra of the substrate layer exceeded 15 nm, a stamping defect of the ceramic green sheet occurred, which increased a short-circuit rate of the MLCC.

As a result, referring to Table 3 and Table 4 above, it can be seen that the release films manufactured in Inventive Examples 1-1 to 4-2 were more suitable for the manufacturing process of multilayer electronic components, especially MLCCs.

The present disclosure is not limited by the embodiments and the attached drawings, but may be intended to be limited by the appended claims. Accordingly, various forms of substitution, modification, and change may be made by those skilled in the art within the scope that does not depart from the technical idea of the present disclosure described in the claims, and this will also fall within the scope of the present disclosure.

In addition, the expression ‘an embodiment’ does not mean an identical embodiment, but may be provided to emphasize and explain each unique feature that may be different from the others. However, the embodiments do not exclude implementations in combination with features of other embodiments. For example, even if a matter described in a specific embodiment may not be described in another embodiment, it may be understood as a description related to the other embodiment, unless there may be a description that may be contrary or contradictory to that matter in the other embodiment.

As one of various effects of the present disclosure, a release film capable of forming a ceramic green sheet with fewer defects may be provided.

While example embodiments have been illustrated and described above, it will be apparent to those skilled in the art that modifications and variations could be made without departing from the scope of the present disclosure as defined by the appended claims.

What is claimed is:

1. A release film comprising:
a substrate layer; and
a release layer disposed on a first surface of the substrate layer, and including a cured product of a release composition,
wherein, when a surface of the release layer is analyzed using X-ray photoelectron spectroscopy (XPS), a ratio (Si/C) of an amount (at %) of silicon to an amount (at %) of carbon is 0.15 to 0.20, and a surface hardness measured by a nanoindentation method is 200 MPa to 300 MPa, and
a second surface of the substrate layer facing the first surface has a center line average roughness Ra of 15 nm or less.

2. The release film of claim 1, wherein the second surface of the substrate layer has a maximum height roughness Rmax of 300 nm or less.

3. The release film of claim 1, wherein surface energy of the release layer is 28 mN/m to 30 mN/m.

4. The release film of claim 1, wherein an average thickness of the release layer is 70 nm to 250 nm.

5. The release film of claim 1, wherein the release composition includes polydimethylsiloxane and a cyclic compound.

6. The release film of claim 5, wherein the cyclic compound includes at least one of an aromatic compound or a heteroaromatic compound.

7. The release film of claim 5, wherein the cyclic compound includes at least one of a melamine-based compound, a pyridine-based compound, or a naphthalene-based compound.

8. The release film of claim 5, wherein the cyclic compound includes melamine.

9. The release film of claim 5, wherein the cyclic compound includes ammeline.

10. The release film of claim 5, wherein the cyclic compound includes naphthalenediamine.

11. The release film of claim 5, wherein the cyclic compound includes dicarboxyphenylpyridine.

12. The release film of claim 5, wherein an amount of polydimethylsiloxane included in the release composition is 1 to 15 parts by weight, based on 100 parts by weight of a sum of the polydimethylsiloxane and the cyclic compound.

13. The release film of claim 5, wherein the release composition further includes an acid catalyst and a solvent.

14. The release film of claim 1, wherein the release layer is substantially free of fluorine (F).

15. A method for manufacturing a multilayer electronic component comprising:
forming a ceramic green sheet on the release film of claim 1;
forming an internal electrode pattern on the ceramic green sheet;
peeling off the ceramic green sheet from the release film and stacking a plurality of the ceramic green sheets to form a ceramic stack; and
sintering the ceramic stack.
